(19) United States
(12) Patent Application Publication
(10) Pub. No.: US 2005/0138854 A1
(43) Pub. Date: Jun. 30, 2005

(54) Distinguishing means for container

(76) Inventor: Adele Simmons, Hampton (CA)

Correspondence Address: BIRCH STEWART KOLASCH & BIRCH, PO BOX 747, FALLS CHURCH, VA, 22040-0747, US

(21) Appl. No.: 11/022,640

(22) Filed: Dec. 28, 2004

(30) Foreign Application Priority Data
Dec. 29, 2003 (CA) 2,454,318

(51) Int. Cl. G09F 3/14

(52) U.S. Cl. 40/665; 40/306; 40/310

(57) ABSTRACT

An O-ring is attached to a container such as a bottle or can which contains a soft drink intended for consumption by a single individual. The O-ring has an inner diameter less than the outer diameter of the container and is composed of material which resiliently deforms so that the O-ring may be stretched to encircle the container after which, when loosened, it squeezes into contact with the container and remains attached to it. The O-ring is provided with indicia such as a name-tag or a distinctive colour or combination or colours in order to distinguish the container to which the O-ring is attached from other like containers.

### FIELD OF THE INVENTION

This invention relates to method of distinguishing a container such as a bottle or can from other like containers. The invention also relates to a container having indicia which distinguishes it from other like containers. More particularly, the invention relates to a method of distinguishing a container by means of indicia such as a name-tag or colour-coding and to a container having such indicia.

### BACKGROUND OF THE INVENTION

It is conventional for children or teenagers to drink soft drinks out of a can or bottle. The contents of each container is intended to be consumed by one person only and usually contains about 350 ml. That quantity is chosen because, under normal circumstances, it is sufficient to quench the thirst of an average teenager or child who is approaching his teens.

Where there are a number of young persons gathered together, such as at a party, each young person is usually offered one can or bottle with the intention that he will consume the entire contents of the container before he comes back for another. However in the excitement and confusion of a party, the young person may put a bottle or can down before he has finished its contents and he may be unable to find it later when he is ready for another drink from it. In such circumstances, the young person will usually open another can or bottle and the unconsumed contents of the first container will be wasted.

### SUMMARY OF THE INVENTION

I have found that such waste can be eliminated by attaching indicia such as a name-tag to each bottle or can before it is handed to a person who intends to drink from it. The tag is attached by means of an O-ring which may be stretched so that it will encircle the container and which will squeeze tightly to the container when it is no longer stretched. The name of the person to whom it is handed is written on the tag so that the person will always be able to identify his can or bottle whether or not he pays attention to where he puts it down before he finishes it. In that way, when the person is ready for another drink he can find his container and he will not have to open a new one.

Instead of a name-tag, the O-ring may be colour-coded so that it can be distinguished from all other O-rings. The colour-coding will make it possible for the person whose container is colour-coded in this manner to recognize the container and to consume its entire contents before he opens a new one.

The method of my invention briefly involves the steps of: (a) providing a plurality of O-rings each having an inner diameter less than the outer diameter of the container and being composed of material which resiliently deforms so that the O-ring may be stretched to encircle the container after which, when loosened, it squeezes into contact with the container and remains attached thereto. The next step involves (b) providing each O-ring with indicia which distinguishes it from all other O-rings; and (c) attaching each O-ring to a separate container by stretching the O-ring to encircle the separate container and by loosening it to cause it to squeeze into contact with the container.

The container of my invention is provided with an O-ring having an inner diameter less than the outer diameter of the container and is composed of material which resiliently deforms so that it may be stretched to encircle the container after which, when loosened, squeezes into contact with the container and remains attached thereto. The O-ring is provided with indicia which distinguishes the container to which the O-ring is attached from other like containers.

### DESCRIPTION OF THE DRAWING

The combination of my invention is described with reference to the accompanying drawing in which:

FIG. 1 is a perspective view of the combination of name-tag and O-ring in combination with a conventional can for a soft drink;

FIG. 2 is a perspective view of the combination of name-tag and O-ring;

FIG. 3 is a perspective view of a second embodiment of the O-ring; and

FIG. 4 is a perspective view of the combination of name-tag and O-ring and a conventional bottle for a soft drink.

Like reference characters refer to like parts throughout the description of the drawing.

### DESCRIPTION OF PREFERRED EMBODIMENTS

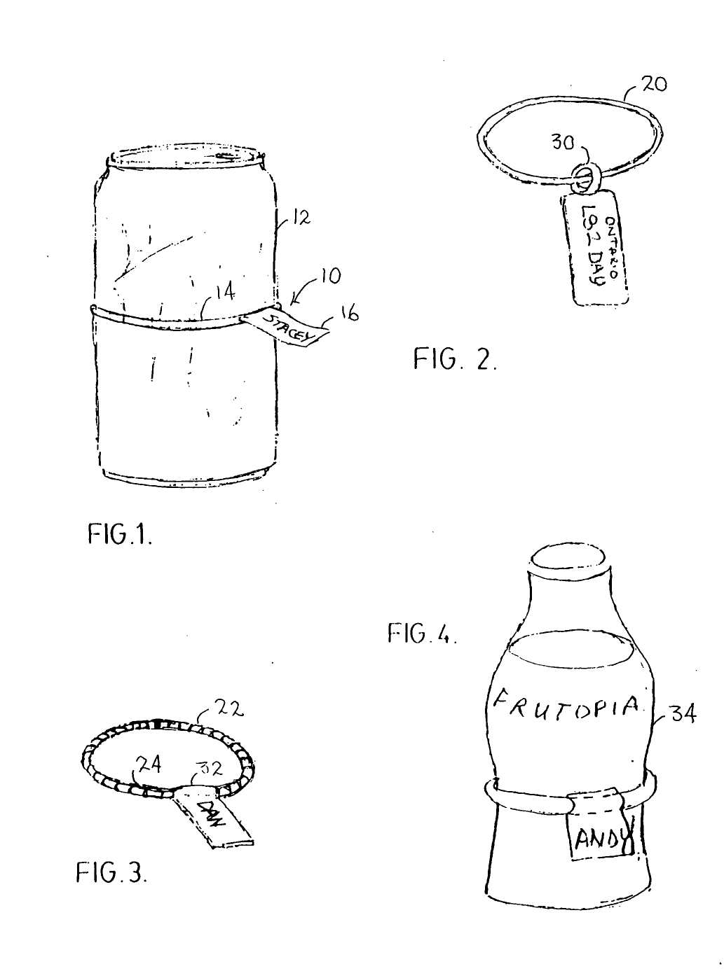

With reference to FIG. 1, an O-ring, generally 10, is shown in combination with a can 12 for a soft drink. The can is of conventional size where it is intended to hold sufficient liquid to satisfy the needs of a single individual. In general, such a can will hold about 350 ml. of liquid.

The O-ring 14 encircles the outer wall of the can and a name-tag 16 is attached to the can by conventional means. The O-ring is composed of resilient material, such as rubber or plastic, and its inner diameter is slightly less than the outer diameter of the can so that it must be stretched to fit around the can. When the O-ring is around the can as illustrated, the O-ring is no longer stretched and will resume it original shape. As it does so, it squeezes into contact with the outer wall of the can and frictionally attaches to it so that it will not separate from the can of its own accord. The only way it will separate is if it is stretched as before.

With reference to FIG. 2, the O-ring 20 is composed of the same material throughout its cross-section. As before, rubber or plastic are suitable material. The O-ring does not have an outer layer or sheath of some other material and is to be contrasted with the O-ring illustrated in FIG. 3 where the O-ring 22 has a core of resilient material, such as rubber or plastic, and an outer layer 24 of cloth or yarn. The cloth or yarn can be multi-coloured to make it more attractive than an outer layer of a single colour. Alternatively, the outer layer can be colour-coded so that children who cannot read can distinguish their cans from others.

In FIG. 2, the name-tag is attached to the O-ring by means of an eyelet 30 through which the O-ring passes. In FIG. 3 the name-tag is provided with a tab 32 which is folded around the O-ring and is glued upon itself in order to attach the name-tag to the O-ring.

In FIG. 4, the combination of name-tag and O-ring is shown in conjunction with a bottle 34. The bottle is intended to contain sufficient liquid to satisfy the requirements of an individual and its capacity is similar to the can of FIG. 1.

It will be understood, of course, that modifications can be made in the invention described and illustrated herein without departing from the scope and purview of the invention as defined in the following claims.

1. A method of distinguishing one container from a number of other like containers each of which being in the form of a bottle or can, said method including the steps of: (a) providing a plurality of O-rings each having an inner diameter less than the outer diameter of said container and being composed of material which resiliently deforms so that said O-ring may be stretched to encircle said container after which, when loosened, it squeezes into contact with said container and remains attached thereto; (b) providing each said O-ring with indicia which distinguishes each said O-ring from all other said O-rings; and (c) attaching each said O-ring to a separate said container.

2. The method of claim 1 further including the step of (d) attaching a name-tag to each said O-ring, said name-tag being the indicia of said step (b).

3. The method of claim 1 further including the step of (d) providing each said O-ring with an outer wall of a colour or combination of colours different from that of all other said O-rings, said outer wall being the indicia of said step (b).

4. In combination, an O-ring and a container in the form of a bottle or can, said O-ring having an inner diameter less than the outer diameter of said container and being composed of material which resiliently deforms so that said O-ring may be stretched to encircle said container and which, when no longer so stretched, squeezes into contact with said container and remains attached thereto, said O-ring being provided with indicia which distinguishes said container to which said O-ring is attached from other like containers.

5. The combination of claim 4 wherein said indicia is a name-tag which is attached to said O-ring and which has a surface on which a name can be displayed.

6. The combination of claim 4 wherein said O-ring has an outer wall which is provided with a colour or combination of colours which distinguishes said container to which said O-ring is attached from other like containers, said colour or colours serving as said indicia

7. The combination of claim 4 wherein said O-ring has a core composed of resilient material and a sheath which surrounds said core and which is composed of cloth or yarn.
